(19) United States
(12) Patent Application Publication
(10) Pub. No.: US 2012/0181826 A1
(43) Pub. Date: Jul. 19, 2012

(54) Occupant Classification System Sensor Covers and Seat Assemblies With Protected Occupant Classification System Sensors

(75) Inventors: Jeffrey Wallace Sosnowski, Ann Arbor, MI (US); John Fredrik Runske, Ann Arbor, MI (US)

(73) Assignee: Toyota Motor Engineering & Manufacturing North America, Inc., Erlanger, KY (US)

(21) Appl. No.: 13/005,937

(22) Filed: Jan. 13, 2011

(51) Int. Cl. B60N 2/44; G01D 11/24; B60N 2/16

(52) U.S. Cl. 297/217.1; 73/431

(57) ABSTRACT

Occupant classification system (“OCS”) sensor covers include a sensor cover portion with an interior cavity, wherein the sensor cover portion at least partially covers an OCS sensor when the OCS sensor cover is connected to a seat assembly, and a link arm cover portion pivotally connected to a rear of the sensor cover portion, wherein the link arm cover portion includes a crossbar connector extending from a free end of the link arm cover portion, wherein the crossbar connector rotatably couples the link arm cover portion to a crossbar of the seat assembly, and wherein the link arm cover portion transitions between a raised position and a lowered position when the seat assembly moves through a vertical range of motion such that the link arm cover portion shields a link arm of the seat assembly throughout the vertical range of motion.

### TECHNICAL FIELD

The present specification generally relates to occupant classification system sensors and, more specifically, to covers for occupant classification system sensors in seat assemblies.

### BACKGROUND

Passenger vehicles can include height adjustable seats for the front passengers. Such seats may include various sensors in the seat bottom including, for example, occupant condition system (OCS) sensors which can be utilized to detect the presence of an occupant in the seat. For example, OCS sensors can detect the downward pressure a passenger may exert on a seat assembly when they are seated. Such information can be utilized by systems of the passenger vehicle to dictate the operation of other vehicle systems such as whether the air bag will deploy in the event of a collision, or whether the seat heater can activate. However, because the seat assemblies can be height adjustable, it is possible for passengers seated in the rear of the vehicle to place their feet beneath the front seats and contact the OCS sensor or otherwise interfere with the seat assembly's height adjustment mechanisms. Such incidental contact can lead to false readings by the OCS sensors or inhibit the passenger seat's height adjustment functionality of the seat.

Accordingly, a need exists for alternative covers for protecting OCS sensors and link arms of seat assemblies while the seat assemblies transition throughout a vertical range of motion.

### SUMMARY

In one embodiment, an occupant classification system (“OCS”) sensor cover may include a sensor cover portion with an interior cavity, the sensor cover portion at least partially covering an OCS sensor when the OCS sensor cover is connected to a seat assembly, and a link arm cover portion pivotally connected to a rear of the sensor cover portion, the link arm cover portion including a crossbar connector extending from a free end of the link arm cover portion, wherein the crossbar connector rotatably couples the link arm cover portion to a crossbar of the seat assembly, and wherein the link arm cover portion transitions between a raised position and a lowered position when the seat assembly moves through a vertical range of motion such that the link arm cover portion shields a link arm of the seat assembly throughout the vertical range of motion.

In another embodiment, a seat assembly with a protected occupant classification system (“OCS”) sensor is disclosed. The seat assembly may include a seat support frame that supports a passenger seat, a rail assembly connected to the seat support frame that transitions the passenger seat in a forward and rearward direction, wherein the seat support frame includes an upper side support and a lower side support connected by a link arm, an OCS sensor connected to the seat assembly such that it can sense downward pressure on the seat support frame created by an occupant sitting in the passenger seat, and an OCS sensor cover. The OCS sensor cover can include a sensor cover portion including an interior cavity, the sensor cover portion at least partially covering the OCS sensor when the OCS sensor is connected to a seat assembly, and a link arm cover portion pivotally connected to a rear of the sensor cover portion, the link arm cover portion comprising a crossbar connector extending from a free end of the link arm cover portion, wherein the crossbar connector rotatably couples the link arm cover portion to the crossbar of the seat assembly, and wherein the link arm cover portion transitions between a raised position and a lowered position when the seat assembly moves through a vertical range of motion such that the link arm cover portion shields a link arm of the seat assembly throughout the vertical range of motion.

In yet another embodiment, an occupant classification system (“OCS”) sensor cover may include a sensor cover portion including an interior cavity, wherein the sensor cover portion at least partially covers an OCS sensor when the OCS sensor is connected to the seat assembly, and a link arm cover portion pivotally connected to a rear of the sensor cover portion, the link arm cover portion including a crossbar connector extending from a free end of the link arm cover portion, wherein the crossbar connector rotatably couples the link arm cover portion to a crossbar of the seat assembly, the link arm cover portion including a first portion pivotally connected to the sensor cover portion with a first living hinge and a second portion pivotally connected to the first portion with a second living hinge, and wherein the link arm cover portion transitions between a raised position where the second portion is extended from the first portion and a lowered position where the second portion is folded over the first portion as the seat assembly moves through a vertical range of motion such that the link arm cover portion shields a link arm of the seat assembly throughout the vertical range of motion.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of a seat assembly with an OCS sensor cover with the link arm cover portion in a raised position according to one or more embodiments shown and described herein;

FIG. 2 depicts a perspective view of a seat assembly with an OCS sensor cover with the link arm cover portion in a lowered position according to one or more embodiments shown and described herein;

FIG. 3 depicts a perspective view of an OCS sensor cover with the link arm cover portion in a raised position according to one or more embodiments shown and described herein;

FIG. 4A depicts a perspective view of an OCS sensor cover in a lowered position according to one or more embodiments shown and described herein;

FIG. 4B depicts a side view of an OCS sensor cover in a lowered position according to one or more embodiments shown and described herein;

FIG. 5A depicts a perspective view of another OCS sensor cover in a raised position according to one or more embodiments shown and described herein;

FIG. 5B depicts a side view of another OCS sensor cover with the link arm cover portion transitioning between a raised position and a lowered position according to one or more embodiments shown and described herein; and

FIG. 6 depicts a cross section view of an OCS sensor in a seat assembly according to one or more embodiments shown and described herein.

### DETAILED DESCRIPTION

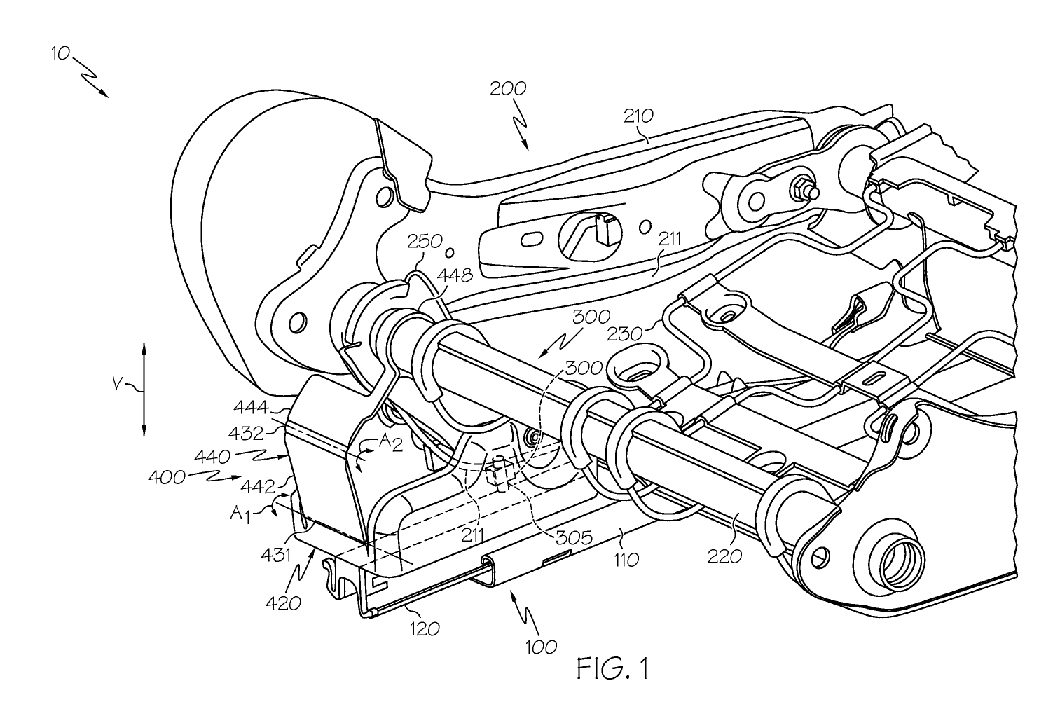

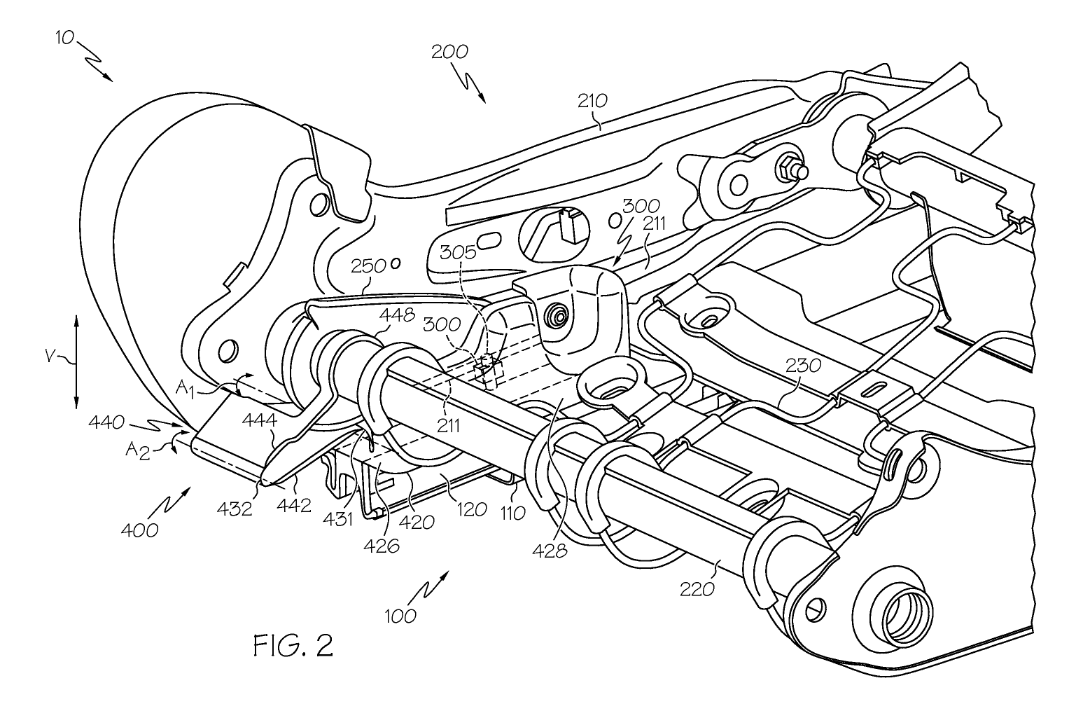

FIGS. 1 and 2 generally depict one embodiment of an occupant classification system (“OCS”) sensor in a seat assembly protected by a sensor cover. The OCS sensor can be installed in the seat assembly to detect the presence of a passenger in the seat. The OCS sensor cover generally comprises a sensor cover portion that at least partially covers the OCS sensor to prevent contact from people (or objects) disposed behind the seat assembly (such as passengers in a rear seat). The OCS sensor cover further comprises a link arm cover portion that extends from the sensor cover portion and is pivotally connected to a crossbar of the seat assembly. The link arm cover portion can transition between a raised position and a lowered position as the seat assembly moves relative to the rail assembly such that the link arm cover portion shields a link arm of the seat assembly from incidental contact. Various embodiments of OCS sensor covers and the operation of the OCS sensors and OCS sensor covers in a seat assembly will be described in more detail herein.

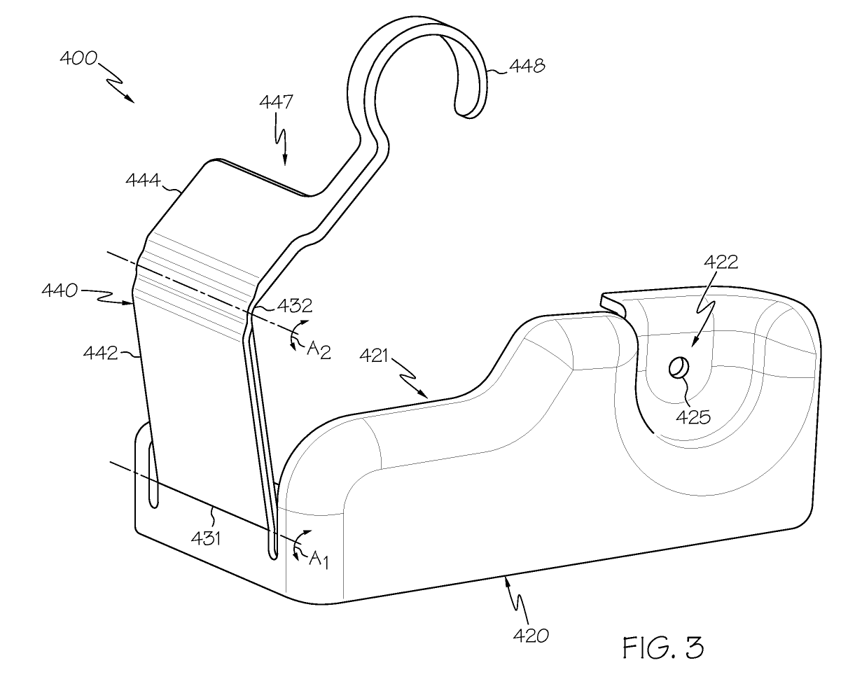

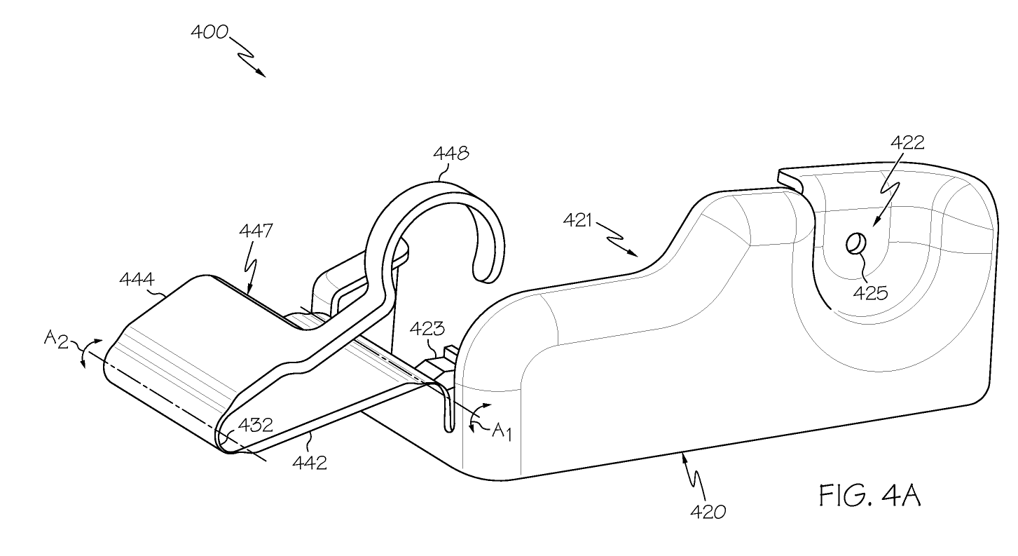

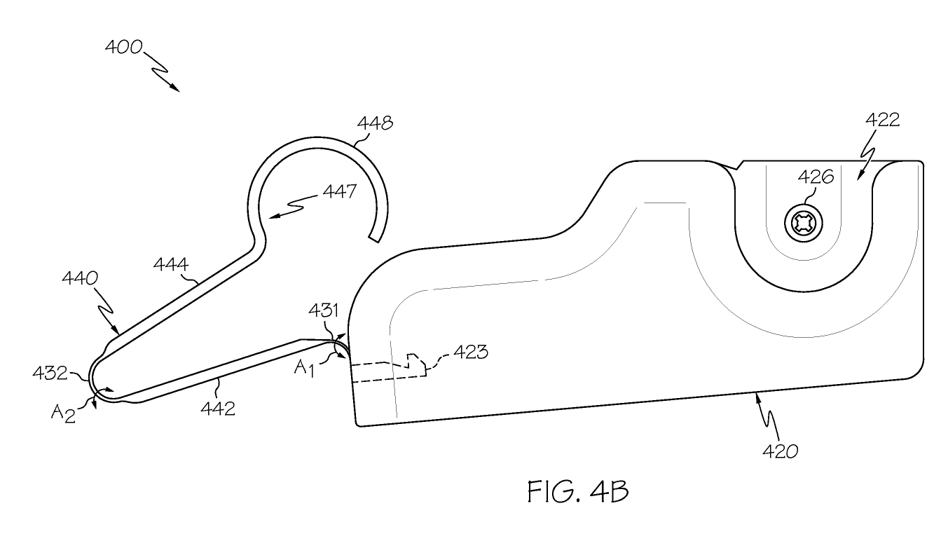

Referring now to FIGS. 1-4B, an OCS sensor cover 400 generally comprises a sensor cover portion 420 and a link arm cover portion 440. The sensor cover portion 420 (as best illustrated in FIGS. 3 and 4) generally comprises an interior cavity 421 that can at least partially cover an OCS sensor 300 when attached to a seat assembly 10, as will be described in more detail herein. Specifically, the sensor cover portion 420 is configured to be placed around at least a portion of the OCS sensor 300 to prevent contact with the OCS sensor 300. The sensor cover portion 420 can thereby prevent unintentional interference with the OCS sensor 300 such that the OCS sensor 300 does not provide an improper status of an occupant in the seat assembly 10 (such as by falsely reading that an occupant is present when no occupant is present, or by falsely reading that no occupant is present when an occupant is present). In some embodiments, the sensor cover portion 420 can comprise a connection detent 422 and/or a connection opening 425 to assist in the connection of the OCS sensor cover 400 to the seat assembly 10. The sensor cover portion 420 may additionally or alternatively comprise one or more clips to snap to one or more locations of the seat assembly 10. For example, as illustrated in FIGS. 4A and 4B, the sensor cover portion 420 can comprise a first clip 423 to snap to a portion of the seat assembly 10, such as the lower side support 211.

In some embodiments, such as that illustrated in FIGS. 1-4B, the sensor cover portion 420 comprises one or more solid walls having a concave interior surface that defines the interior cavity 421. In some embodiments, the sensor cover portion 420 comprises a wall with gaps or openings that allows visual access to the OCS sensor 300 but still prevents large objects (such as the feet of a passenger sitting behind the seat assembly 10) from contacting the OCS sensor 300. In some embodiments, such as that illustrated in FIGS. 1-4B, the sensor cover portion 420 may comprise a single outer wall 428 that extends along the rail assembly 100 of a seat assembly 10. In such embodiments, the sensor cover portion 420 may be configured such that the outer wall 428 is disposed towards the center portion of seat assembly 10. In some alternative embodiments (not shown), the sensor cover portion 420 may comprise two outer walls 428 disposed on either side of the rail assembly 100. Accordingly, it should be understood that the sensor cover portion 420 may comprise other additional or alternative walls that further define the interior cavity 421 and prevent access to an OCS sensor 300 when the OCS sensor 300 is connected to the seat assembly 10.

Referring still to FIGS. 1-4B, the OCS sensor cover 400 further comprises a link arm cover portion 440 that shields a link arm 250 of the seat assembly 10 throughout a vertical range of motion V of the seat assembly 10 as will be discussed in more detail herein. Specifically, the link arm cover portion 440 transitions between a raised position (as illustrated in FIGS. 1 and 3) and a lowered position (as illustrated in FIGS. 2, 4A and 4B) as the seat assembly moves vertically up and down, respectively. The link arm cover portion 440 has a first pivotal connection 431 to a back 426 of the sensor cover portion 420 and a free end 447 of the link arm cover portion 440 extends away from the sensor cover portion 420. The first pivotal connection 431 allows the pivotally connected link arm cover portion 440 to rotate about a first rotational axis A₁ relative to the sensor cover portion 420. The first pivotal connection 431 allows the link arm cover portion 440 to rotate about any rotational range relative to the sensor cover portion 420 that permits the link arm cover portion 440 to transition between the raised position (as illustrated in FIGS. 1 and 3) and the lowered position (as illustrated in FIGS. 2, 4A and 4B) as will be discussed in more detail herein.

The link arm cover portion 440 further comprises a free end 447 (i.e., an end that is not connected to the sensor cover portion 420) that can rotatably couple the link arm cover portion 440 to the seat assembly 10. For example, in some embodiments, the free end 447 comprises a crossbar connector 448 that connects to a crossbar 220 of the seat support frame 200 of the seat assembly 10 as depicted in FIGS. 3 and 4A-4B. The crossbar connector 448 can comprise a releasable connection such as a hook (as illustrated in FIGS. 1-4B) or any other suitable connector that allows the link arm cover portion to transition between the raised position and the lowered position as the seat assembly 10 transitions throughout a vertical range of motion V.

Still referring to FIGS. 1-4B, in some embodiments, the link arm cover portion 440 comprises a plurality of pivotally connected portions that assist in the raising and lowering of the link arm cover portion 440. For example, as illustrated, the link arm cover portion 440 can comprise a first portion 442 pivotally connected to the back 426 of the sensor cover portion 420 at the first pivotal connection 431. In this embodiment, the link arm cover portion 440 also comprises a second portion 444 pivotally connected to and extending away from the first portion 442 at a second pivotal connection 432. The crossbar connector 448 attached thereto can then be disposed at the free end 447 of the second portion 444. Similar to the first pivotal connection 431, the second pivotal connection 432 allows the second portion 444 to rotate about a second rotational axis A₂ relative the first portion 442 of the link arm cover portion 440. The second pivotal connection 432 allows the second portion 444 to rotate about any rotational range relative to the first portion 442 that permits the link arm cover portion 440 to transition between the raised position (as illustrated in FIGS. 1 and 3) and the lowered position (as illustrated in FIGS. 2, 4A and 4B). For example, when the link arm cover portion 440 is rotated from the raised position (FIG. 3) to the lowered position (FIGS. 4A and 4B), the first portion 442 is rotated counter-clockwise about the first rotational axis A₁ while the second portion 444 is rotated clockwise about the second rotational axis A₂ until the link arm cover portion 440 is in the lowered position. Similarly, when the link arm cover portion 440 is rotated from the lowered position (FIGS. 4A and 4B) to the raised position (FIG. 3), the second portion 444 is rotated counter-clockwise about the second rotational axis A₂ while the first portion 442 is rotated clockwise about the first rotational axis A₁ until the link arm cover portion 440 is in the raised position. Accordingly, it should be understood that as the link arm cover portion 440 is rotated between the lowered and raised positions, the first portion 442 and the second portion 444 of the link arm cover portion 440 rotate in opposite directions about their respective axes of rotation (i.e., A₁ and A₂).

The first pivotal connection 431 and the second pivotal connection 432 can comprise any type of pivotal connection that allows for rotation about the first rotational axis A₁ and the second rotational axis A₂, respectively. In some embodiments, such as that illustrated in FIGS. 1-4B, the first pivotal connection 431 between the sensor cover portion 420 and the link arm cover portion 440 comprises a living hinge (i.e., a thin flexible strip of material across the first pivotal connection 431). The living hinge at the first pivotal connection 431 allows the link arm cover portion 440 to be integral with the sensor cover portion 420 such that the entire OCS sensor cover 400 can be formed as a unitary structure. Likewise, the second pivotal connection 432 can similarly comprise a living hinge to allow rotation about the second rotational axis A₂. The living hinge at the second pivotal connection 432 similarly allows the link arm cover portion 440 (or at least the first portion 442 and the second portion 444 of the link arm cover portion 440) to be formed as a unitary structure.

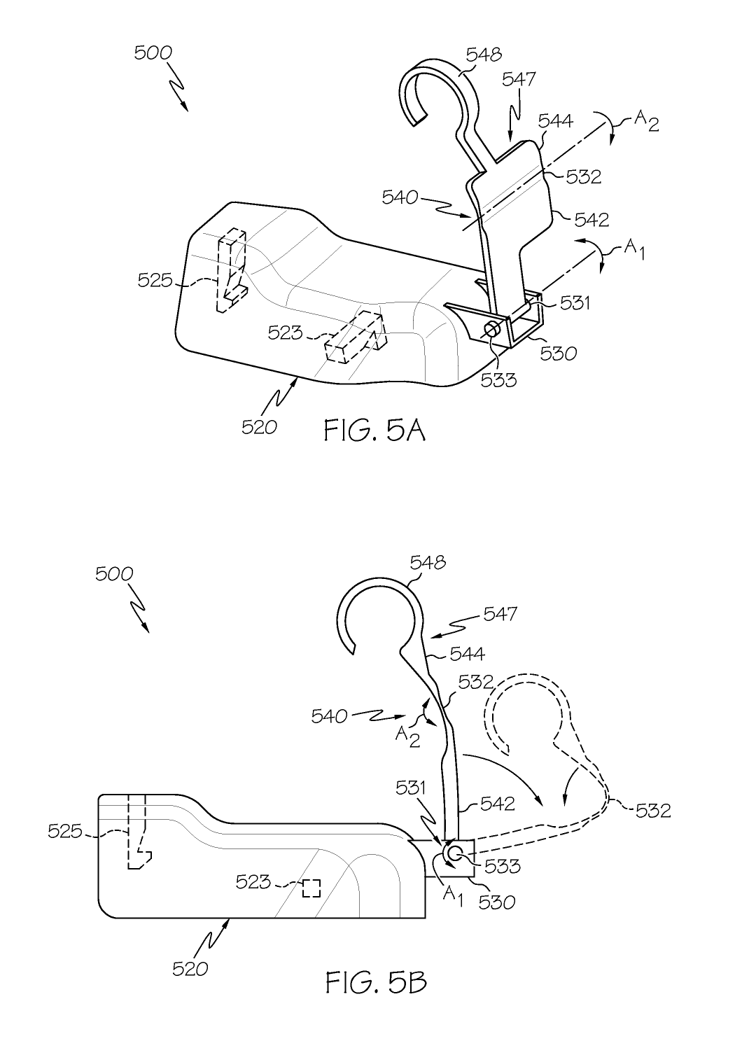

Referring now to FIGS. 5A and 5B, an alternative embodiment of an OCS sensor cover is illustrated in which the link arm cover portion is pivotally connected to the sensor cover portion with a pin connection instead of a living hinge. Specifically, the alternative OCS sensor cover 500 comprises a sensor cover portion 520 and a link arm cover portion 540. The link arm cover portion 540 comprises a first portion 542 pivotally connected to the sensor cover portion 520 at a first axis of rotation A₁ at the first pivotal connection 531. The link arm cover portion 540 further comprises a second portion 544 connected to the first portion 542 at a second axis of rotation A₂ at a second pivotal connection 532, wherein the second portion 544 extends to a free end 547 of the link arm cover portion 540. In the embodiment shown in FIGS. 5A and 5B, the first portion 542 is pivotally connected to the second portion 544 with a living hinge, as described above. The link arm cover portion 540 further comprises a crossbar connector 548 to connect the link arm cover portion 540 to the cross bar of a seat assembly. The first portion 542 of the link arm cover portion 540 connects to a U-shaped extension 530 of the sensor cover portion 520 with a pin 533 to form the first pivotal connection 531. Specifically, the pin 533 is integrally formed with the link arm cover portion 540 and the connection at the first axis of rotation A₁ pivotally connects the link arm cover portion 540 to the sensor cover portion 520 at the U-shaped extension 530 of the sensor cover portion 520. The pin 533 connection allows two separate pieces (i.e., a sensor cover portion 520 and a separate link arm cover portion 540) to be connected so that the alternative OCS sensor cover 500 is not necessarily one integral structure. In some embodiments of the pin connection, the pin 533 can be connected between two closed holes on the U-shaped extension 530 (as illustrated). In some embodiments, one or both of the holes on the U-shaped extension 530 that the pin 533 connects to may have a lateral slot such that the pin 533 can slide down through the lateral slot and snap into the hole. Furthermore, a pin connection can additionally or alternatively be used at the second pivotal connection 532 to allow the second portion 544 of the link arm cover portion 540 to rotate relative to the first portion 542 of the link arm cover portion 540.

In operation, the sensor cover portion 520 at least partially covers an OCS sensor while the link arm cover portion 540 transitions between a raised position (as illustrated in FIGS. 5A and 5B) and a lowered position (as illustrated by the broken lines in FIG. 5B). Specifically, the crossbar connector 548 remains pivotally attached to the crossbar of the seat assembly so that as the seat assembly is raised, the crossbar connector 548 follows the rising seat assembly and causes the link arm cover portion 540 to rotate counter-clockwise about the first rotational axis A₁ and into the raised position. To facilitate this motion, the crossbar connector 548 pivots on the crossbar while the second portion 544 rotates about the second rotational axis A₂ relative to the first portion 542 so that the first portion 542 and the second portion 544 are more in-line with each other in an extended orientation. Then, as the seat assembly is lowered into the lowered position, the crossbar connector 548 follows the lowering seat assembly and causes the link arm cover portion 540 to rotate clockwise about the first rotational axis A₁ and into the lowered position. During the transition, the second portion 544 rotates about the second rotational axis A₂ relative to the first portion 542 so that the first portion 542 and the second portion 544 are bent into the lowered position (as illustrated with the broken lines in FIG. 5B). This allows for the link arm cover portion 540 to shield the link arm of the seat assembly throughout a vertical range of motion of the seat assembly.

It should be understood that other implementations of a pin connection may additionally be realized such that the link arm cover portion 540 is pivotally connected to the sensor cover portion 520 and is thereby able to rotate about a first axis of rotation A₁. For example, in an alternative embodiment, the pin may be formed on the rear of the sensor cover portion 520 and the U-shaped extension 530 may be formed on the link arm cover portion 540.

As illustrated in FIGS. 5A and 5B, the alternative OCS sensor cover 500 also comprises a first clip 523 and a second clip 525 disposed in the interior cavity 521 that enables a snap-on connection to a part of the seat assembly (such as the lower side support). By utilizing a plurality of clips (i.e., the first clip 523 and the second clip 525), the sensor cover portion 520 can connect to the seat assembly without the need for a detent and/or a connection opening as incorporated in the embodiment illustrated in FIGS. 1 and 2.

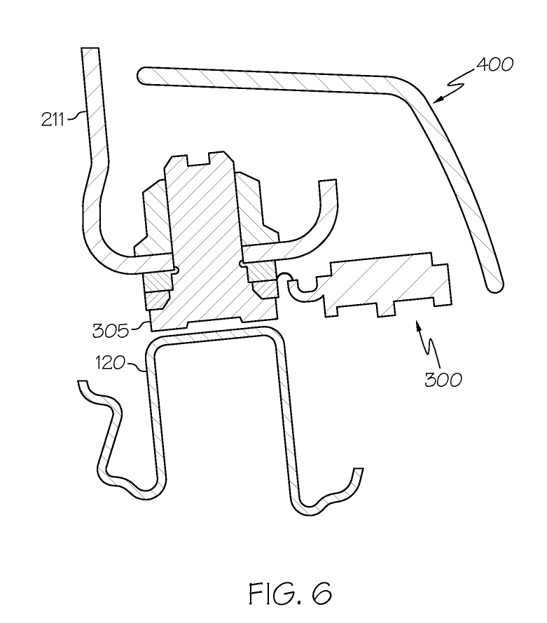

Referring to FIGS. 1-6, the OCS sensor cover 400 is generally formed from polymeric materials. For example, referring to FIGS. 1-4B, in embodiments where the sensor cover portion 420 is integral with the link arm cover portion 440, the OCS sensor cover 400 comprises a polymeric material that can be injection molded. Such materials may include, polyethylene or similar injection moldable polymeric materials. In some embodiments, the OCS sensor cover 400 can comprise a plurality of materials, such as in the embodiment illustrated in FIGS. 5A and 5B where the sensor cover portion 520 and the link arm cover portion 540 are two separate parts connected by a pin connection. In this embodiment, the sensor cover portion 520 and the link arm cover portion 540 may be formed from the same material or from different materials.

Referring now to FIGS. 1, 2 and 6, the OCS sensor cover 400 can be incorporated into a seat assembly 10 to cover and shield the OCS sensor 300 and the link arm 250 as the seat assembly 10 moves throughout a vertical range of motion V. The seat assembly 10 generally comprises a rail assembly 100 that connects to a seat support frame 200. The rail assembly 100 allows the forward and rearward movement of the seat assembly 10 such as when the passenger in the seat assembly 10 desires additional or reduced leg room. In some embodiments, such as that illustrated in FIGS. 1, 2 and 6, the rail assembly 100 comprises a lower rail 110 and an upper rail 120. The lower rail 110 can be secured to the floor of a vehicle and the upper rail 120 may be moveably attached to the lower rail 110 such that the upper rail 120 can move in the forward and reward directions.

The seat support frame 200 supports the passenger seat (i.e., cushions) and facilitates positioning the seat assembly 10 over a vertical range of motion V, such as when the seat assembly 10 comprises one or more actuators (not shown) for adjusting the vertical position of the seat. As best seen in FIGS. 1 and 2, the seat support frame 200 of the seat assembly 10 comprises upper side supports 210 and lower side supports 211 that run parallel with the rail assembly 100 and are disposed on the inboard (i.e., center portion of the vehicle) and the outboard (i.e., outside portion of the vehicle) sides. The upper side supports 210 are connected by one or more crossbars 220 that extend across the width of the seat and the crossbars 220 can be connected to the lower side support 211 by a link arm 250. The upper side supports 210, lower side supports 211 and/or the one or more crossbars 220 can further support a frame assembly 230 that supports the cushions of the passenger seat.

The seat support frame 200 is connected to the rail assembly 100 to facilitate the forward and rearward motion of the seat support frame 200 with the rail assembly 100, while also allowing the seat support frame 200 to move in a vertical range of motion V relative to the rail assembly 100. For example, as illustrated in FIGS. 1 and 2, the seat support frame 200 can be connected to the rail assembly 100 by the lower side support 211 to allow forward and rearward directional movement of the seat assembly 10. Moreover, the link arm 250 rotatably connects the lower side support 211 to the crossbar 220, which itself is connected to an upper side support 210. Thus, when the seat assembly 10 is raised vertically, the link arm 250 pivots with respect to the upper side support 210 and lower side support 211 into a more vertical position (as illustrated in FIG. 1). When the seat assembly is lowered vertically, the link arm 250 pivots with respect to the upper side support 210 and the lower side support into a more horizontal position (as illustrated in FIG. 2).

As discussed above, an OCS sensor 300 can be connected to the seat assembly 10 to sense the presence of a person or object in the passenger seat. For example, as illustrated in FIGS. 1, 2 and 6, the OCS sensor 300 can be disposed between the lower side support 211 and the upper rail 120. Specifically, the OCS sensor 300 can be connected to the lower side support 211, such as by a threaded connector 305 (e.g., bolt, screw or the like) and/or one or more clips, such that the OCS sensor 300 is isolated from the upper rail 120. By connecting the OCS sensor 300 to the lower side support 211 in isolation of the upper rail 120, the OCS sensor 300 can move with the lower side support 211 relative to the upper rail 120 so that the pressure exerted on the seat assembly can be monitored without the influence of any forces exerted by the rail assembly 100.

The OCS sensor cover 400 is also connected to the seat support frame 200 in isolation of the rail assembly 100 so that it continuously covers the OCS sensor 300 when the seat support frame 200 moves forward, rearward and/or vertically. For example, in some embodiments, the sensor cover portion 420 of the OCS sensor cover 400 can be connected to the lower side support 211 (or any other element which the OCS sensor 300 is connected to) of the seat support frame 200 by one or more bolts, snaps, clips, adhesives, or the like. Thus, the OCS sensor 300 will remain disposed in the interior cavity 421 of the sensor cover portion 420 as the seat assembly moves throughout a vertical range of motion V.

Moreover, the link arm cover portion 440 of the OCS sensor cover 400 can rotatably couple to another part of the seat support frame 200 (such as the crossbar 220) such that the link arm cover portion 440 raises and lowers with the vertical movement of the seat support frame 200 of the seat assembly 10. Specifically, referring to FIG. 1, in operation, the seat assembly 10 may initially start in a raised orientation wherein the seat support frame 200 is elevated over the rail assembly 100. With the seat assembly 10 in this orientation, the link arm 250 is disposed in a substantially vertical orientation. To maintain shielding of the relatively vertical link arm 250, the link arm cover portion 440 of the OCS sensor cover 400 is oriented into the raised position wherein the first portion 442 and the second portion 444 are vertically raised (i.e., the second portion 444 is extended from the first portion 442) relative to the sensor cover portion 420 by rotating about the first axis of rotation A₁ and the second axis of rotation A₂, respectively.

Referring now to FIGS. 1 and 2, the seat support frame 200 of the seat assembly can transition through its vertical range of motion V into a lowered orientation wherein the seat support frame 200 is lowered relative to the rail assembly 100. In this orientation, the link arm 250 is disposed in a more horizontal orientation as it rotates about the crossbar 220 while the crossbar 220 lowers. To maintain shielding of the relatively horizontal link arm 250, the link arm cover portion 440 of the OCS sensor cover 400 is oriented into the lowered position (i.e., the second portion 444 is folded over the first portion 442) such that the first portion 442 and the second portion 444 rotate about the first axis of rotation A₁ and the second axis of rotation A₂, respectively. By transitioning between the raised position (FIG. 1) and the lowered position (FIG. 2), the link arm cover portion 440 can continuously shield the link arm 250 as it moves with the seat support frame 200 of the seat assembly 10 throughout a vertical range of motion V.

It should now be appreciated that OCS sensor covers can be incorporated in seat assemblies to at least partially cover an OCS sensor and shield a link arm while the seat assembly transitions throughout a vertical range of motion. By isolating the connection of the OCS sensor and the sensor cover portion of the OCS sensor cover to the seat assembly (and not the rail assembly), the OCS sensor cover can partially block the OCS sensor as it senses the presence of a person or object in the seat which also improves the accuracy of signals from the OCS sensor. Moreover, by pivotally connecting the link arm cover portion of the OCS sensor cover to the sensor cover portion, and rotatably coupling the link arm cover portion to a crossbar of the seat assembly, the link arm cover portion can transition between raised and lowered positions to shield the link arm of the seat assembly throughout a vertical range of motion of the seat assembly. The OCS sensor cover can thereby prevent accidental interference from passengers or objects in the rear of a seat assembly with the OCS sensor and the link arm of the seat assembly throughout the transitional movement of the seat assembly.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An occupant classification system (“OCS”) sensor cover comprising:
a sensor cover portion comprising an interior cavity, the sensor cover portion at least partially covering an OCS sensor when the OCS sensor cover is connected to a seat assembly; and
a link arm cover portion pivotally connected to a back of the sensor cover portion, the link arm cover portion comprising a crossbar connector extending from a free end of the link arm cover portion, wherein the crossbar connector rotatably couples the link arm cover portion to a crossbar of the seat assembly, and wherein the link arm cover portion transitions between a raised position and a lowered position when the seat assembly moves through a vertical range of motion such that the link arm cover portion shields a link arm of the seat assembly throughout the vertical range of motion.

2. The OCS sensor cover of claim 1, wherein the link arm cover portion comprises a first portion connected to the sensor cover portion and a second portion pivotally connected to the first portion.

3. The OCS sensor cover of claim 2, wherein the first portion is pivotally connected to the sensor cover portion with a living hinge.

4. The OCS sensor cover of claim 2, wherein the second portion is pivotally connected to the first portion with a living hinge.

5. The OCS sensor cover of claim 1, wherein the crossbar connector comprises a hook.

6. The OCS sensor cover of claim 1, wherein the link arm cover portion is pivotally connected to the back of the sensor cover portion with a living hinge.

7. The OCS sensor cover of claim 1, wherein the link arm cover portion is pivotally connected to the back of the sensor cover portion with a pin.

8. The OCS sensor cover of claim 1, wherein the sensor cover portion comprises a connection detent comprising a connection opening, wherein the connection opening of the sensor cover portion aligns with a reciprocal opening on the seat assembly to allow a threaded connection there between.

9. A seat assembly with a protected occupant classification system (“OCS”) sensor, the seat assembly comprising:
a seat support frame that supports a passenger seat;
a rail assembly connected to the seat support frame that transitions the passenger seat in a forward and rearward direction, wherein the seat support frame comprises an upper side support and a lower side support connected by a link arm;
an OCS sensor connected to the seat assembly such that the OCS sensor senses a downward pressure on the seat support frame; and
an OCS sensor cover comprising:
a sensor cover portion comprising an interior cavity, the sensor cover portion attached to the seat support frame such that the sensor cover portion at least partially covers the OCS sensor when the OCS sensor is connected to the seat assembly; and
a link arm cover portion pivotally connected to a back of the sensor cover portion, the link arm cover portion comprising a crossbar connector extending from a free end of the link arm cover portion, wherein the crossbar connector rotatably couples the link arm cover portion to a crossbar of the seat assembly, and wherein the link arm cover portion transitions between a raised position and a lowered position when the seat assembly moves through a vertical range of motion such that the link arm cover portion shields the link arm of the seat assembly throughout the vertical range of motion.

10. The seat assembly of claim 9, wherein the OCS sensor is connected to the seat support frame in isolation from the rail assembly.

11. The seat assembly of claim 10, wherein the sensor cover portion of the OCS sensor cover is connected to the seat support frame in isolation from the rail assembly.

12. The seat assembly of claim 11, wherein the OCS sensor and the sensor cover portion of the OCS sensor cover are connected to a lower side support of the seat support frame.

13. The seat assembly of claim 9, wherein the link arm cover portion comprises a first portion connected to the sensor cover portion and a second portion pivotally connected to the first portion.

14. The seat assembly of claim 13, wherein the first portion is pivotally connected to the sensor cover portion with a living hinge.

15. The seat assembly of claim 13, wherein the second portion is pivotally connected to the first portion with a living hinge.

16. The seat assembly of claim 9, wherein the crossbar connector comprises a hook.

17. The seat assembly of claim 9, wherein the link arm cover portion is pivotally connected to the back of the sensor cover portion with a living hinge.

18. The seat assembly of claim 9, wherein the link arm cover portion is pivotally connected to the back of the sensor cover portion with a pin.

19. An occupant classification system (“OCS”) sensor cover comprising:
a sensor cover portion comprising an interior cavity, the sensor cover portion at least partially covering an OCS sensor when the OCS sensor is connected to a seat assembly; and
a link arm cover portion pivotally connected to a back of the sensor cover portion, the link arm cover portion comprising a crossbar connector extending from a free end of the link arm cover portion, wherein the crossbar connector rotatably couples the link arm cover portion to a crossbar of the seat assembly, the link arm cover portion comprising a first portion pivotally connected to the sensor cover portion with a first living hinge and a second portion pivotally connected to the first portion with a second living hinge, and wherein the link arm cover portion transitions between a raised position where the second portion is extended from the first portion and a lowered position where the second portion is folded over the first portion as the seat assembly moves through a vertical range of motion such that the link arm cover portion shields a link arm of the seat assembly throughout the vertical range of motion.

20. The OCS sensor cover of claim 19, wherein the sensor cover portion comprises a connection detent comprising a connection opening, wherein the connection opening of the sensor cover portion aligns with a reciprocal opening on the seat assembly to allow a threaded connection there between.
